(19) United States
(12) Patent Application Publication
(10) Pub. No.: US 2017/0094069 A1
(43) Pub. Date: Mar. 30, 2017

(54) IMAGE FORMING APPARATUS

(71) Applicant: Sharp Kabushiki Kaisha, Osaka (JP)

(72) Inventors: Hiroki KANEMITSU, Osaka (JP); Noriaki TAGUCHI, Osaka (JP); Shinichi TAKEDA, Osaka (JP)

(21) Appl. No.: 15/270,417

(22) Filed: Sep. 20, 2016

(30) Foreign Application Priority Data
Sep. 24, 2015 (JP) 2015-186279
Aug. 31, 2016 (JP) 2016-168687

(51) Int. Cl. H04N 1/00

(52) U.S. Cl. CPC H04N 1/00037; H04N 1/00381; H04N 1/00891; H04N 1/00058

(57) ABSTRACT

An image forming apparatus includes an apparatus main body that performs an image forming process, and a detection device provided in the apparatus main body and detects a user who approaches the apparatus main body. The detection device has a detection range of which a bottom line is inclined obliquely upward when viewed from a horizontal direction.

### CROSS REFERENCE

This Nonprovisional application claims priority under 35 U.S.C. 119(a) on Patent Application No. 2015-186279 filed in Japan on Sep. 24, 2015 and Patent Application No. 2016-168687 filed in Japan on Aug. 31, 2016, the entire contents of which are hereby incorporated by reference.

### BACKGROUND OF THE INVENTION

1. Field of the Invention

The present invention relates to an image forming apparatus capable of detecting a user who approaches.

2. Description of Related Art

Conventionally, among the image forming apparatus there is known one that switches over to a sleep mode in which power supply to a number of mounted devices other than part of control devices is stopped when a predetermined time passes in a state of its not being used and returns from the sleep mode to a normal mode when its operation portion is touched by a user. For instance, the apparatus stops heating a fixing device when switching over to the sleep mode, and resumes heating the fixing device when returning to the normal mode. For this reason, it has often taken a long time for the conventional image forming apparatus to return from the sleep mode to the normal mode and thus to become ready for normal use.

Then, there has been proposed a technology that enables the image forming apparatus to automatically return from the sleep mode to the normal mode by detecting a user who approaches the apparatus with a detection sensor (for example, see Japanese Unexamined Patent Application Publication No. 11-202690 Bulletin).

Also, there has been proposed another technology that enables the apparatus to display a detection range of the detection sensor at an operation portion, to accept an alteration setting of an orientation of the detection sensor by a user at the operation portion, and to change the detection range of the detection sensor by changing the orientation of the detection sensor based on the alteration setting that has been accepted at the operation portion (for example, see Japanese Unexamined Patent Application Publication No. 2014-109723 Bulletin).

However, with a mere provision of the detection sensor in the image forming apparatus as described in JP 11-202690, it has been difficult to determine accurately whether a user who is detected by the detection sensor is the one who approaches the image forming apparatus or not.

Also, in order to change the orientation of the detection sensor as described in JP 2014-109723, a complex mechanism to cause the detection sensor to rotate is required. Further, it is difficult to control the orientation of the detection sensor with a high angular accuracy; therefore, it has been difficult to adjust the detection range accurately so that the detection sensor is capable of detecting the user who approaches.

### SUMMARY OF THE INVENTION

An image forming apparatus according to the present invention includes an apparatus main body that performs an image forming process, and a detection device provided in the apparatus main body and detects a user who approaches the apparatus main body. The detection device has a detection range of which a bottom line is inclined obliquely upward when viewed from a horizontal direction.

### BRIEF DESCRIPTION OF THE DRAWINGS

FIG. 1 is a perspective view showing an outline of an image forming apparatus according to a first embodiment.

FIGS. 2A and 2B are drawings on a detection device showing two examples where orientations of a detection face of a detection sensor are different.

FIGS. 3A and 3B are drawings on the detection device showing two examples where positions of installation of the detection device are different.

FIG. 4A is a perspective view showing a detection device according to a second embodiment, and FIG. 4B is a partially cutaway perspective view of the detection device.

FIGS. 5A and 5B are front views showing two states of a shutter portion in the detection device.

FIG. 6 is a perspective view showing a state in which a front cover of an image forming portion in the image forming apparatus is located at an open position.

FIG. 7 is a enlarged perspective view showing an enlarged main part of the image forming apparatus shown in FIG. 6.

FIGS. 8A and 8B are drawings on the detection device showing two examples where orientations of the detection face of the detection sensor are different.

### DETAILED DESCRIPTION OF THE EMBODIMENTS

### First Embodiment

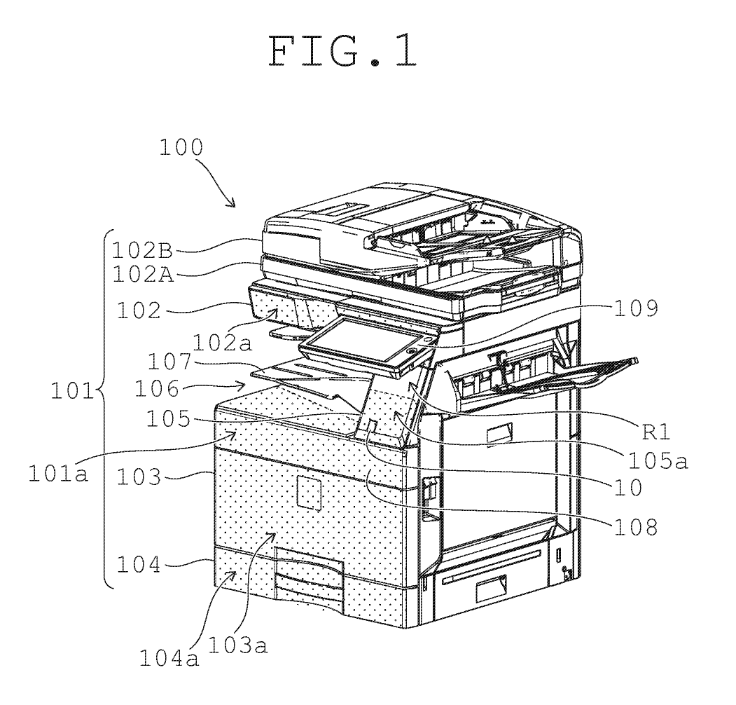

As shown in FIG. 1, an image forming apparatus 100 according to a first embodiment includes an apparatus main body 101 that performs a printing process onto a paper sheet. The apparatus main body 101 includes an image reading portion 102, an image forming portion 103, and a paper feeding portion 104. The image reading portion 102 performs an image reading process that reads an image of a document and generates image data. The image forming portion 103 performs an image forming process that forms an image onto a paper sheet based on the image data. As an example, the image forming portion 103 performs an image forming process according to the electrophotographic method. The paper feeding portion 104 supplies paper sheets that are accepted therein to the image forming portion 103. The paper sheets that are accepted in the paper feeding portion 104 are not limited to normal paper, but include various sheets that are printable, such as thick paper, OHP film and so on.

In the apparatus main body 101, the image reading portion 102, the image forming portion 102, and the paper feeding portion 104 are disposed in this order from an upper side downward. A document table is formed on a top face of the image reading portion 102. In this embodiment, the apparatus main body 101 further includes a cover portion 102A that covers the document table, and an automated conveyance portion 102B that is provided in the cover portion 102A. The cover portion 102A is supported openably on the top face of the image reading portion 102.

Also, between the image reading portion 102 and the image forming portion 103, a cavity portion 106 that extends in horizontal directions is provided partially leaving a column portion 105. In this embodiment, the column portion 105 is disposed at an end portion on the right side of the apparatus main body 101 when the image forming apparatus 100 is viewed from its front. Also, a front face 105a of the column portion 105 consists of an inclined face that is oriented obliquely upward. That is, in a front face 101a of the apparatus main body 101, an inclined face that is oriented obliquely upward is partially formed. The column portion 105 is not limited to be disposed at the end portion on the right side of the apparatus main body 101, but may be at an end portion on the left side or a rear end portion of the apparatus main body 101.

A paper receiving tray 107 is provided in the cavity portion 106, and paper sheets that are discharged after having undergone printing are piled on the paper receiving tray 107. Specifically, the paper sheets that are supplied from the paper feeding portion 104, after undergoing the image forming process at the image forming portion 103, are discharged from the column portion 105 in a horizontal direction to the cavity portion 106. Then, the paper sheets that are discharged to the cavity portion 106 are piled on the paper receiving tray 107.

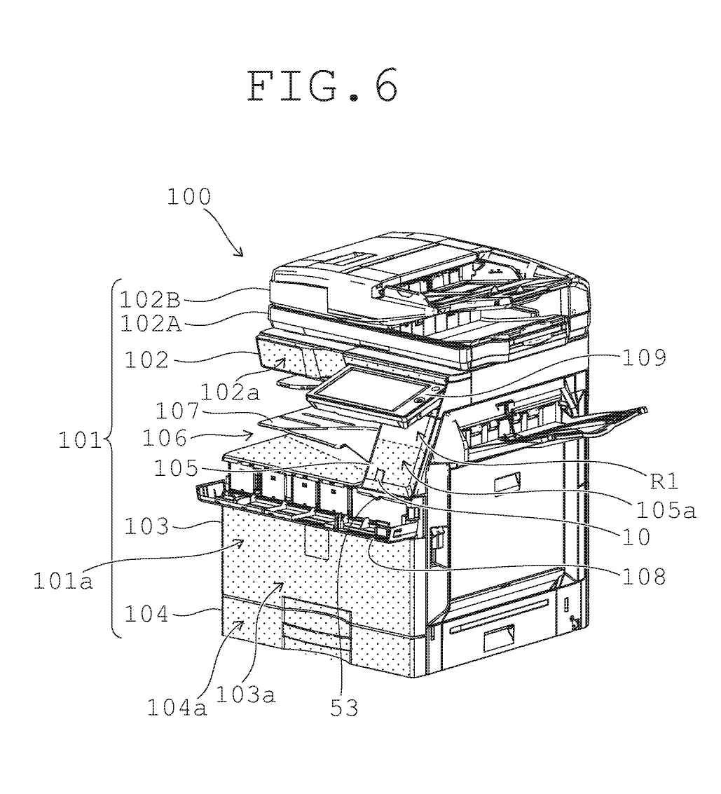

The image forming portion 103 has an openable front cover 108 that forms a part of the front face 101a of the apparatus main body 101. Specifically, the front cover 108, a lower edge portion of which is supported by the apparatus main body 101 in such a manner as to be allowed to rotationally move so that an upper edge portion of which can be moved backward and forward, is capable of reciprocating movement between a close position (position of the front cover 108 shown in FIG. 1) and an open position (position of the front cover 108 shown in FIG. 6). When the front cover 108 is brought to the open position, at least part of an internal mechanism of the image forming portion 103 is exposed to outside. On the other hand, when the front cover 108 is brought to the close position, the inside of the image forming portion 103 is covered by the front cover 108, and thus becomes invisible.

As shown in FIG. 1, the image forming apparatus 100 further includes an operation portion 109 that is provided in the front face 101a of the apparatus main body 101. In this embodiment, the operation portion 109 consists of a LCD touch panel and at least one operation key. The operation portion 109 is used for displaying information about for example the image forming process or the image reading process, and for input operations by a user.

Also, the operation portion 109 is supported by the apparatus main body 101 in such a manner as to be allowed to rotationally move from a posture at which the operation portion 109 partially covers the front face 101a. Specifically, the operation portion 109 is supported at a position right above the column portion 105 on the front face 101a of the apparatus main body 101 (a front face 102a of the image reading portion 102), and can be rotationally moved from a posture at which the operation portion 109 covers an area R1 in the front face 105a of the column portion 105.

As shown in FIG. 1, the image forming apparatus 100 further includes a detection device 10. The detection device 10 is provided in the apparatus main body 101, and detects a user who approaches the image forming apparatus 100. In the image forming apparatus 100, a face in which the operation portion 109 is disposed in the apparatus main body 101 usually becomes the front face 101a of the apparatus main body 101. Also, when the users move toward the operation portion 109 in order to perform an operation, they tend to approach the image forming apparatus 100 from the front face 101a's side of the apparatus main body 101. For this reason, from the viewpoint of detecting a user who approaches, it is preferable that the detection device 10 is provided in the front face 101a of the apparatus main body 101.

In this embodiment, the detection device 10 is provided, in particular, in the front face 105a (inclined face) of the column portion 105 in the front face 101a of the apparatus main body 101. Specifically, the detection device 10 is provided at a position in the inclined face, and the position is set to be lower than the area R1 that can be covered by the operation portion 109 so as not to be covered by the operation portion 109.

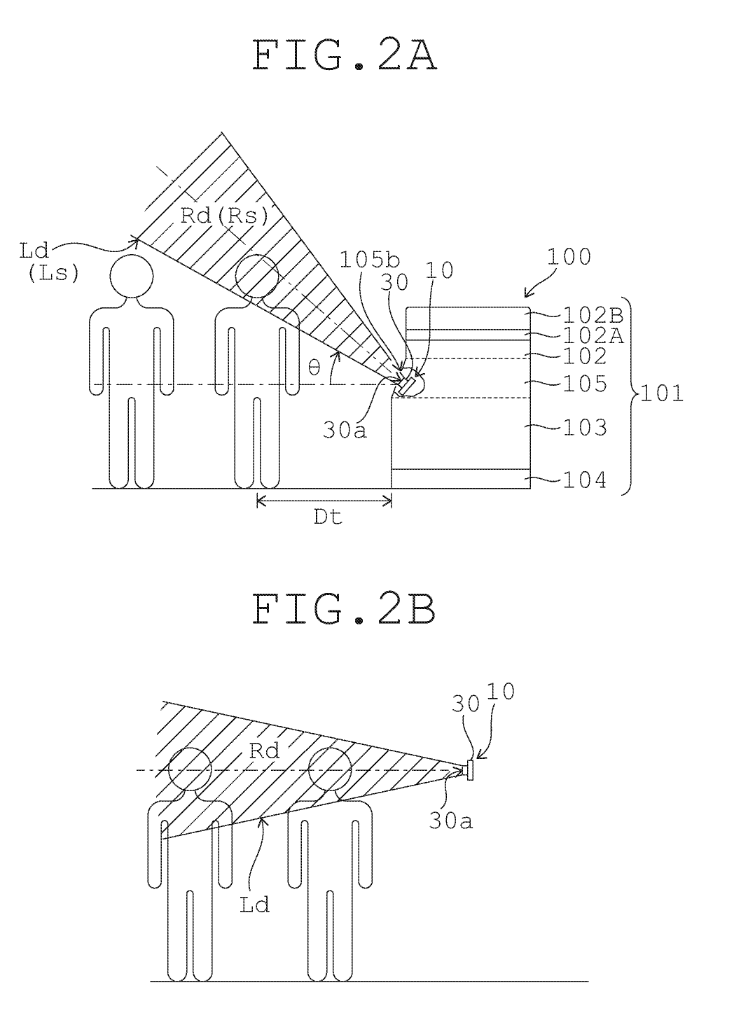

As shown in FIG. 2A, the detection device 10 includes a detection sensor 30 capable of detecting a user, and the detection sensor 30 is provided in the column portion 105 with a detection face 30a thereof being oriented obliquely upward. In this embodiment, the detection sensor 30 is disposed inside the column portion 105, and detects the user through a window 105b with light permeability that is provided in a front face wall of the column portion 105. The detection sensor 30 has a detection range Rd within which a user is detectable, and the detection range Rd itself constitutes a detection range Rs of the detection device 10. In this embodiment, an infrared sensor is used as the detection sensor 30.

Specifically, as to the detection sensor 30, orientation of its detection face 30a is set in such a manner that a bottom line Ld of the detection range Rd (in agreement with a bottom line Ls of a detection range Rs in the detection device 10) is inclined obliquely upward when viewed from a horizontal direction. More specifically, the orientation of the detection face 30a is adjusted when the detection sensor 30 is installed, and thereby an inclination angle θ of the bottom line Ld with respect to the horizontal line is adjusted to a desired angle. In FIG. 2A, the horizontal line is shown by a dashed line.

In this manner, by having the bottom line Ld of the detection range Rd inclined obliquely upward, it is made possible to accurately detect a user who approaches the image forming apparatus 100. Specific explanations are as follows: First, as shown in FIG. 2B, let us consider a case where the bottom line Ld of the detection range Rd is inclined obliquely downward by having the detection face 30a oriented, for example, in the horizontal direction. In this case, when a user passes in the vicinity of the image forming apparatus 100, the user is captured within the detection range Rd regardless of a distance from the image forming apparatus 100 to the user. For this reason, even a user who is not actually approaching the image forming apparatus 100 is detected; then it follows that each time this happens a return from the sleep mode to the normal mode takes place.

On the other hand, as shown in FIG. 2A, in a case where the bottom line Ld is inclined obliquely upward, the more distance from the image forming apparatus 100 is, the more height to the bottom line Ld becomes. Accordingly, when a user approaches to a position that is within a predetermined distance Dt by which it can be determined that the user approaches the image forming apparatus 100, the user's head part can be captured within the detection range Rd. Therefore, it is possible to accurately detect a user who approaches the image forming apparatus 100. Additionally, the user's headpart (primarily face) tends to expose its skin, and thus has a higher temperature than the user's foot part with a shoe being put on. For this reason, the user's head part tends to emit infrared radiation, so that it is easily detected by the infrared sensor.

In this manner, by accurately detecting a user who approaches the image forming apparatus 100, it is made possible for the image forming apparatus 100 to efficiently perform a return from the sleep mode to the normal mode for the benefit of user who wants to operate the image forming apparatus 100. This makes it possible to cause the image forming portion 103 to be driven (for example, to start heating the fixing device) before the user starts operation. Accordingly, the time from when the user starts operation to when the image forming apparatus 100 is actually ready for use is shortened, and thus usability of the image forming apparatus 100 is enhanced.

Additionally, because a user who comes to pickup printed paper sheets tends to approach the image forming apparatus 100 obliquely from one side, detection of such a user is prevented. Therefore, the image forming apparatus 100 is prevented from uselessly returning to the normal mode, and thus energy saving performance of the image forming apparatus 100 is improved.

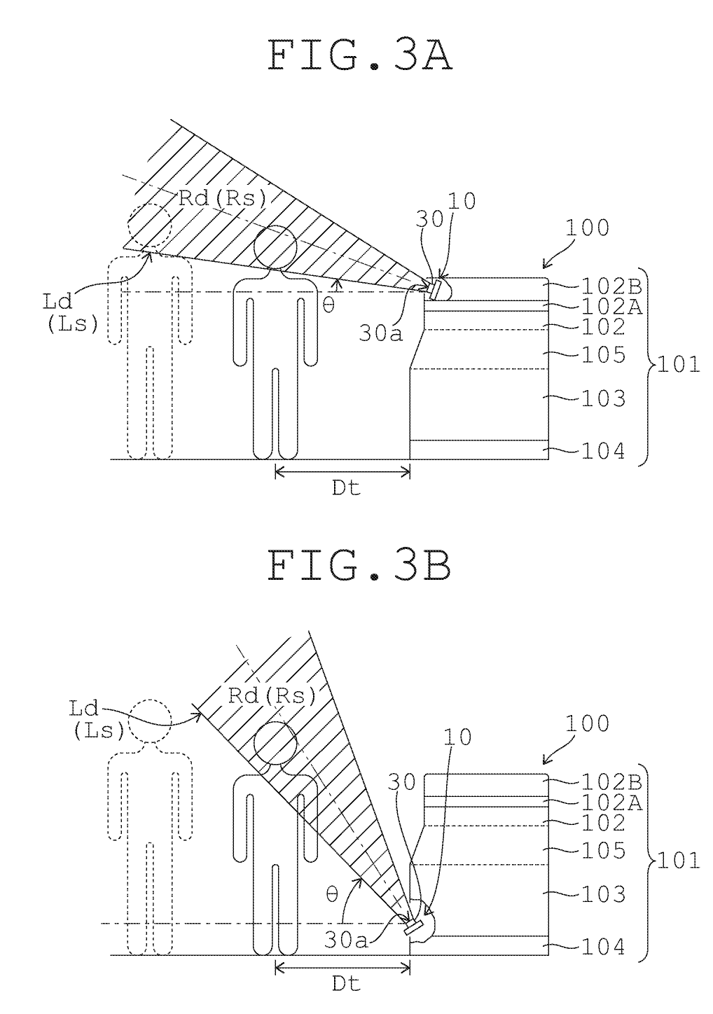

As shown in FIGS. 3A and 3B, the detection sensor 30 is not limited in the front face 105a of the column portion 105, but can be provided at various positions in the front face 101a of the apparatus main body 101. At whichever position it may be, by performing an adjustment of the inclination angle θ as described above when the detection sensor 30 is installed, it is possible to have the bottom line Ld of the detection range Rd oriented obliquely upward. As shown in FIG. 3A, when the detection device 10 is provided at a higher position in the front face 101a (for example, in a front face of the automated conveyance portion 102B), it is necessary to adjust the inclination angle θ to be small in order to detect a user who approaches to a position that is within the predetermined distance Dt. In this case, if a user who is at a position that is farther than the predetermined distance Dt is a tall user (a user shown by a broken line in FIG. 3A), there is a risk that the user is captured within the detection range Rd.

As shown in FIG. 3B, it is preferable that the detection device 10 is provided at a relatively lower position in the front face 101a. This ensures that the inclination angle θ to detect a user who approaches to a position within the predetermined distance Dt becomes large; so that even if a user who is at a position that is farther than the predetermined distance Dt is a tall user (a user shown by a broken line in FIG. 3B), it becomes less likely that the user is captured within the detection range Rd. Therefore, it is made possible to accurately detect a user who approaches.

In this manner, from the viewpoint of improving the detection accuracy, it is preferable that the detection device 10 is provided at a position that is lower than the document table in the front face 101a of the apparatus main body 101. Further, more preferably, the detection device 10 may be provided as described below. In FIGS. 1 and 6, a preferred installation area for the detection device 10 is shown by hatching.

That is, the detection device 10 may be provided in the front face 102a of the image reading portion 102. Or, the detection device 10 may be provided at a position that is lower than the operation portion 109. Specifically, in the front face 105a (inclined face) of the column portion 105, the detection device 10 may be provided at a position that is lower than the area R1 that can be covered by the operation portion 109. Further, the detection device 10 may be provided in a front face 103a of the image forming portion 103, or in a front face 104a of the paper feeding portion 104. Moreover, the detection device 10 may be provided in an inner bottom face of the cavity portion 106, preferably in part of the inner bottom face that is near the front face 101a (an area that is not covered by the paper receiving tray 107).

### Second Embodiment

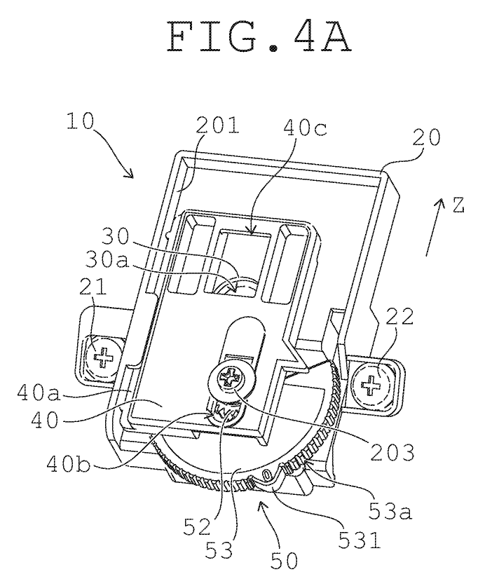

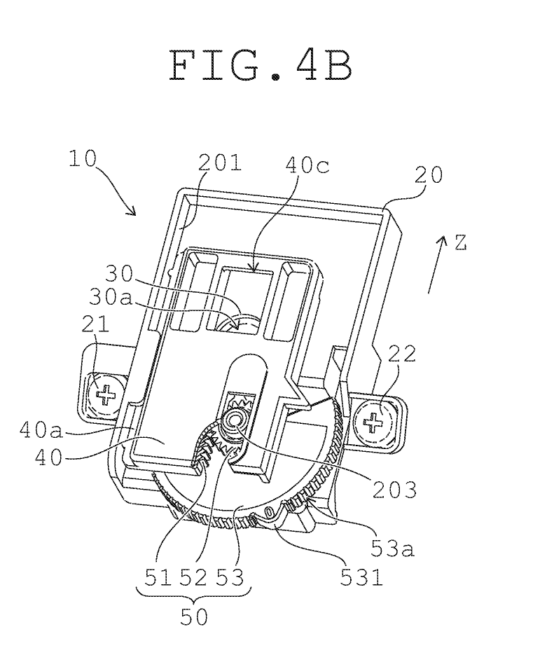

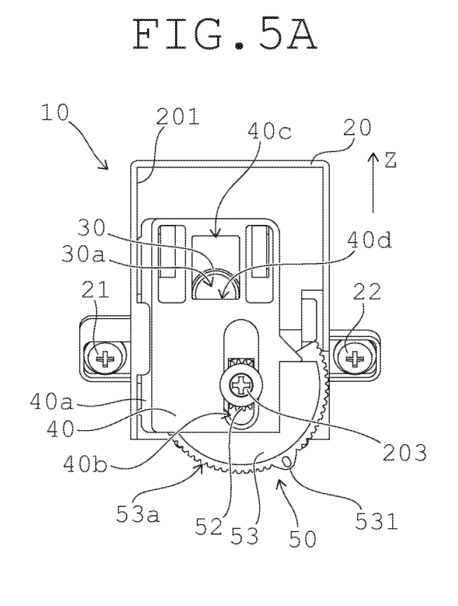

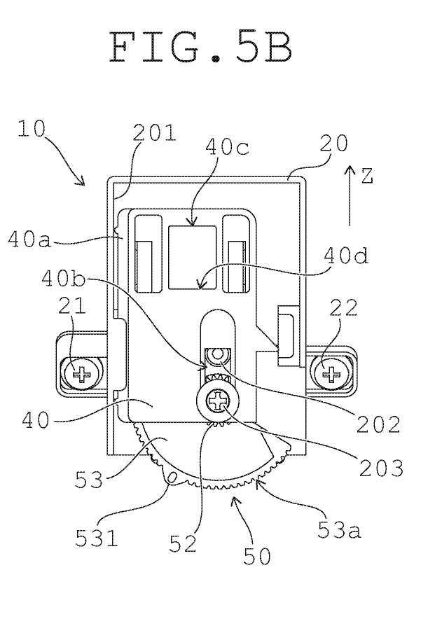

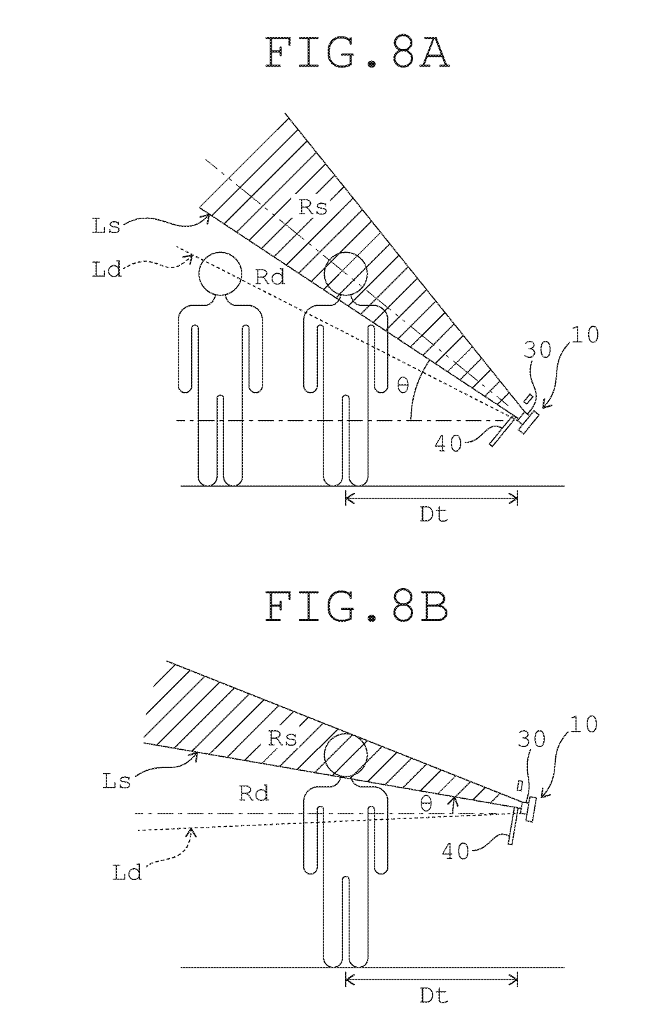

As a second embodiment, a detection device 10 may further include a shutter portion 40, as shown in FIGS. 4A-5B. In this embodiment, the shutter portion 40 can cover the detection range Rd of the detection sensor 30 at least partially from a lower side of the detection range Rd (see FIGS. 8A and 8B). In this embodiment, the detection device 10 further includes a main body portion 20 and a moving mechanism portion 50, in addition to the detection sensor 30 and the shutter portion 40.

The main body portion 20 is attached inside the column portion 105 using bolts 22 and 23, and the detection sensor 30 is fixed to the main body portion 20.

The shutter portion 40 is provided in the main body portion 20 with moving directions thereof being restricted so as to be capable of linear reciprocating movement in a predetermined direction Z. Specifically, the shutter portion 40 has an edge 40a and a slit 40b that extend in the predetermined direction Z. Also, the main body portion 20 has a guide portion 201 that allows the edge 40a of the shutter portion 40 to slide in the predetermined direction z, and two engaging projection portions 202 and 203 that slidably engage with the slit 40b (see FIG. 5B). In this embodiment, both of the engaging projection portions 202 and 203 have cylindrical shapes. In a state of installation of the detection device 10 in the apparatus main body 101, the predetermined direction Z may be vertical direction, or a direction inclined with respect to vertical direction. For example, the inclined direction may be along the front face 105a (inclined face) of the column portion 105.

More specifically, the shutter portion is formed of a material that can obstruct detection by the detection sensor 30 (in this embodiment, a material that can cut-off infrared radiation). The shutter portion 40 is moved to a desired amount in the predetermined direction Z to cover part of the detection range Rd of the detection sensor 30, thereby narrowing or widening the detection range Rs of the detection device 10 to a desired range. Here, “narrowing” means narrowing a width of the detection range Rs in the predetermined direction Z. And, “widening” means widening the width of the detection range Rs in the predetermined direction Z.

The moving mechanism portion 50 is a mechanism that causes the shutter portion 40 to perform a reciprocating movement in the predetermined direction Z and holds the shutter portion 40 at a desired position within a movable range. Specifically, the moving mechanism portion 50 consists of a rack 51, a pinion gear 52, and an operation rotary disk 53 (see FIG. 4B). The rack 51 is provided on a rear face of the shutter portion 40, and extends in the predetermined direction Z. Also, on a side face of the rack 51, a plurality of teeth portions that mesh with the pinion gear 52 are formed.

The pinion gear 52 is formed being integrated with the operation rotary disk 53 sharing the same rotational axis (i.e. coaxial). The pinion gear 52 and the operation rotary disk 53 are disposed on back side of the shutter portion 40, and are pivotally supported on the main body portion 20 by the cylindrical engaging projection portion 203. Additionally, the operation rotary disk 53 has a semicircular shape of which a diameter is bigger than that of the pinion gear 52, and is disposed with an arc-shaped edge 53a thereof oriented toward a direction that is opposite to the predetermined direction Z. Further, part of the edge 53a of the operation rotary disk 53 sticks out of the main body portion 20, and a projection portion 531 for a rotating operation is formed on the sticking out part of the operation rotary disk 53. The edge 53a may be treated with a non-slip processing. Examples of the non-slip processing include surface texturing, knurling and so on. Also, it is preferable that the operation rotary disk 53 has graduations formed thereon, which makes it possible for the user to easily understand a rotational position of the operation rotary disk 53 around the engaging projection portion 203.

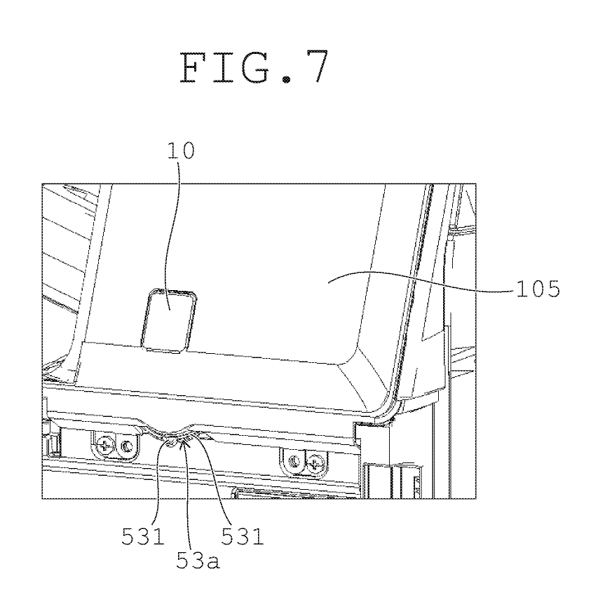

In this embodiment, the detection device 10 is disposed in such a manner that most part thereof is contained inside the column portion 105, and that part of the edge 53a and the projection portion 531 of the operation rotary disk 53 are exposed directly under the column portion 105 when the front cover 108 of the image forming portion 103 is opened, as shown in FIGS. 6 and 7. Accordingly, with the front cover 108 being opened, the user can rotate the operation rotary disk 53 using the projection portion 531. On the other hand, when the front cover 108 is closed, the projection portion 531 is covered by the front cover 108; so that there is no possibility that the user will unintentionally touch the projection portion 531; and thus, misoperation is prevented.

Through the user's operation of the operation rotary disk 53, the pinion gear 52 rotates being interlocked with the rotation of the operation rotary disk 53. As a result, the shutter portion 40 of which the moving direction is restricted to the predetermined direction Z performs a translation motion in the predetermined direction Z via the rack 51 that meshes with the pinion gear 52. This allows the shutter portion 40 to perform a reciprocating motion between an open position that causes the whole of the detection face 30a of the detection sensor 30 to be exposed and a shielding position (see FIG. 5B) that covers and thus shields the whole of the detection face 30a.

In this embodiment, in the shutter portion 40 has a rectangular window 40c that causes the whole of the detection face 30a to be exposed when the shutter portion 40 is located at the open position. Also, a bottom edge 40d of the window 40c is formed of a straight line that is generally perpendicular to the predetermined direction Z (see FIG. 5A). Accordingly, in the course of movement of the shutter portion 40 from the open position to the shielding position, the bottom edge 40d of the window 40c crosses the detection face 30a; as a result, the bottom of the detection range Rs of the detection device 10 becomes planar. The shutter portion 40 is not limited to the one as above-mentioned, but may be one without the window 40c. In this case, a top edge of the shutter portion 40 that is formed of a straight line generally perpendicular to the predetermined direction Z can be a substitute for the bottom edge 40d.

With such a detection device 10, it is made possible to easily change the detection range Rs of the detection device 10 with the detection sensor 30 being fixed to the apparatus main body 101. Specifically, through an adjustment of the position of the shutter portion 40, as shown in FIG. 8A, the bottom line Ls of the detection range Rs can be oriented obliquely upward when viewed from the horizontal direction. That is, it is possible to adjust the inclination angle θ of the bottom line Ls with respect to the horizontal line to a desired angle. Also, as shown in FIG. 8B, even when the detection sensor 30 is disposed in such a manner that the bottom line Ld of the detection range Rd is oriented obliquely downward (or in the horizontal direction) when viewed from the horizontal direction, it is still possible to have the bottom line Ls of the detection range Rs oriented obliquely upward by partially covering the detection range Rd from the lower side thereof through the adjustment of the position of the shutter portion 40.

Therefore, with the detection device 10 in this embodiment, as well as the first embodiment, it is possible to accurately detect a user who approaches the image forming apparatus 100. Additionally, since the inclination angle θ of the bottom line is adjustable, the detection range Rs can be changed accordingly depending on a place, environment and so on where the image forming apparatus 100 is installed. Specifically, the distance from the image forming apparatus 100 within which detection of the user becomes possible (predetermined distance Dt) can be changed accordingly.

As an example, in a case where a user who is within a relatively wide range, for instance within 1.5 m from the image forming apparatus 100, is to be detected, the shutter portion 40 is disposed at such a position as to cover about a third part of the detection face 30a from a lower side thereof. On the other hand, in a case where a user who is within a relatively narrow range, for instance within 30 cm from the image forming apparatus 100, is to be detected (i.e., in a case where a user who comes very close to the image forming apparatus 100 is to be detected), the shutter portion 40 is disposed at such a position as to cover about 90% part of the detection face 30a from the lower side thereof.

The detection device 10 in this embodiment does not require a complex mechanism to rotate the detection sensor 30. Also, since the detection range Rs of the detection device 10 can be changed by just moving the shutter portion 40 linearly, it is possible to carry out a fine adjustment of the position of the shutter portion 40 easily and accurately. Therefore, it is possible to stop the shutter portion 40 accurately at a desired position. Accordingly, with the detection device 10 in this embodiment, notwithstanding simplicity in its structure, it is possible to obtain a desired detection range Rs easily.

Further, since the operation rotary disk 53 has a larger diameter than the pinion gear 52, a rotation angle of the pinion gear 52 can be finely adjusted through the rotating operation of the operation rotary disk 53, thereby making it possible to finely adjust the amount of movement of the shutter portion 40.

In this embodiment, the detection device 10 is configured so that the shutter portion 40 moves continuously in the predetermined direction Z. The detection device 10 is not limited to be configured as such, but may be configured so that the shutter portion 40 may move stepwise (in ca. 3 to 5 steps) in the predetermined direction Z.

Further still, the detection device 10 in this embodiment, making it possible to easily change the detection range Rs of the detection device 10 manually, obviates the need for complicated operations such as changing via a plurality of operations at the operation portion 109. Also, even when the power supply to the image forming apparatus 100 is cut off, it is still possible to change the detection range Rs. Thus, a high level of usability in operation to change the detection range Rs of the detection device 10 has been realized.

Moreover, the detection device 10 may be disposed so that the shutter portion 40 is movable in a horizontal direction (that is to say, so that the predetermined direction Z becomes the horizontal direction). In this case, it is possible to adjust an inclination of a right side edge line or left side edge line of the detection range Rs of the detection device 10 when viewed from vertical direction, depending on the amount of movement of the shutter portion 40; as a result, narrowing or widening of a width of the detection range Rs in the horizontal direction is realized.

### Third Embodiment

As a third embodiment, in a detection device 10, the detection sensor 30 may be disposed or the position of the shutter portion 40 may be adjusted so that a top line of the detection range Rs is oriented obliquely downward when viewed from the horizontal direction. In the latter case, the detection device 10 is disposed so that the shutter portion 40 can partially cover the detection range Rd of the detection sensor 30 from an upper side of the detection range Rd.

With this configuration, the more distance from the image forming apparatus 100 is, the less height to the top line becomes. Accordingly, when a user approaches to a position that is within a predetermined distance Dt by which it can be determined that the user approaches the image forming apparatus 100, the user's foot can be captured within the detection range Rs. Therefore, it is possible to accurately detect a user who approaches the image forming apparatus 100.

### Fourth Embodiment

As a fourth embodiment, the detection sensor 30 may be chosen from various photo-sensors that are not limited to the infrared sensor. Also, the detection sensor 30 may be among various reflection-type sensors such as distance sensor and ultrasonic sensor. In the case of the reflection-type sensor, the detection range Rs of the detection device 10 can be changed by providing the shutter portion 40 with corresponding to either a transmitter or a receiver.

Moreover, further embodiments can be constructed by combining all or some of the technical features each other that have been described in the above-mentioned plurality of embodiments. Also, the above-mentioned detection device 10 can be applied to a variety of apparatus that are not limited to the image forming apparatus.

The above explanations of the embodiments are nothing more than illustrative in any respect, nor should be thought of as restrictive. Scope of the present invention is indicated by claims rather than the above embodiments. Further, it is intended that all changes that are equivalent to a claim in the sense and realm of the doctrine of equivalence be included within the scope of the present invention.

What is claimed is:

1. An image forming apparatus comprising:
an apparatus main body that performs an image forming process; and
a detection device provided in the apparatus main body and detecting a user who approaches the apparatus main body, wherein
the detection device has a detection range of which a bottom line is inclined obliquely upward when viewed from a horizontal direction.

2. The image forming apparatus according to claim 1, wherein
the detection device includes a detection sensor capable of detecting a user; and
the detection sensor is provided in the apparatus main body with a detection face of the detection sensor oriented obliquely upward, so that the bottom line of the detection range of the detection device is inclined obliquely upward.

3. The image forming apparatus according to claim 1, wherein
the detection device includes:
a detection sensor capable of detecting a user; and
a shutter portion capable of covering a detection range of the detection sensor at least partially from a lower side of the detection range, wherein
the detection range of the detection sensor is partially covered by the shutter portion, so that the bottom line of the detection range of the detection device is inclined obliquely upward.

4. The image forming apparatus according to claim 1, wherein
the detection device is provided at a position that is lower than a document table in a front face of the apparatus main body.

5. The image forming apparatus according to claim 4, wherein
an inclined face that is oriented obliquely upward is formed in the front face of the apparatus main body; and
the detection device is provided in the inclined face.

6. The image forming apparatus according to claim 4,
further comprising an operation portion that is provided in the front face of the apparatus main body and can be rotationally moved from a posture at which the operation portion partially covers the front face, wherein
the detection device is provided at a position that is lower than a range that can be covered by the operation portion in the front face of the apparatus main body.

7. The image forming apparatus according to claim 5,
further comprising an operation portion that is provided in the front face of the apparatus main body and can be rotationally moved from a posture at which the operation portion partially covers the front face, wherein
the detection device is provided at a position that is lower than a range that can be covered by the operation portion in the front face of the apparatus main body.

8. The image forming apparatus according to claim 4, wherein
the apparatus main body is configured of an image reading portion, an image forming portion, and a paper feeding portion that are disposed in this order from an upper side downward, the image reading portion has a top face on which the document table is formed, the image forming portion performs an image forming process, and the paper feeding portion supplies a paper sheet to the image forming portion; and
the detection device is provided in a front face of either the image forming portion or the paper feeding portion.
